(19) United States
(12) Patent Application Publication
(10) Pub. No.: US 2005/0066302 A1
(43) Pub. Date: Mar. 24, 2005

(54) Method and system for minimizing thread switching overheads and memory usage in multithreaded processing using floating threads

(75) Inventor: Udayan Rajendra Kanade, Maharashtra (IN)

Correspondence Address: William L, Botjer, PO Box 478, Center Moriches, NY, 11934, US

(73) Assignee: CODITO TECHNOLOGIES PRIVATE LIMITED, MAHARASHTRA (IN)

(21) Appl. No.: 10/667,756

(22) Filed: Sep. 22, 2003

(51) Int. Cl. G06F 9/44

(52) U.S. Cl. 717/100

(57) ABSTRACT

The disclosed invention provides a system, method and computer program product for minimizing thread-switching overheads and memory usage while processing multithreaded application programs. A new type of thread called a floating thread is provided. Floating threads do not require any reference information to be saved in the main memory when the thread is swapped out. A floating thread compiler is used for compiling the main level function of the floating thread. All preemptive functions are called through the main level of floating threads and thread swapping occurs across this main level only. The reference information of a preempted floating thread is minimal and can be stored in fast memory. Execution of a preempted thread resumes not from the point of preemption but at the start of the function that caused the thread to preempt.

### BACKGROUND

The disclosed invention relates generally to multithreaded application processing in computing applications. More specifically, it relates to a system and method for reducing thread switching overheads and minimizing the number of execution stacks used by threads during multithreaded application processing in single processor or multiple processor configurations.

With the development of complex computing applications, modern application programming has become quite intricate. Application programs created these days pose a requirement for extensive processing resources. However, available processing resources may not satisfy this requirement. Hence, it is essential that the available processing resources be optimized. At the same time, the application program needs to be run as efficiently as possible, while still maintaining the process complexities. Use of multithreaded programming has proved to be beneficial in optimizing the available processing resources as well as efficiently running the application program.

In multithreaded programming, an application program is written as a set of parallel activities or threads. A thread is an instance of a sequence of code that is executed as a unit. The partitioning of an application program into multiple threads results in easily manageable and faster program execution. This partitioning in multithreaded programming involves usage of imperative programming. Imperative programming describes computation in terms of a program state and statements that change that program state. Imperative programs are a sequence of commands for the computer to perform. The hardware implementation of most computing systems is imperative in nature. Nearly all computer hardware is designed to execute machine code, which is always written in imperative style. Therefore, complex multithreaded programs are preferably written using an imperative language. Most of the high level languages, like C, support imperative programming.

In multithreaded programming, a compiler compiles the threads associated with an application program before execution of the program. The compiler converts the user-written code to assembly language instructions that can be interpreted by processor hardware. The compiler creates a virtual thread of execution corresponding to a user-written thread. The virtual thread constitutes the user-written thread and an associated data structure for running the thread. This virtual thread is subsequently mapped to the processor during execution. There may be a plurality of virtual threads corresponding to each user-written thread or vice versa, depending upon the application program requirement

Each user-written thread consists of multiple functions that are called sequentially by the processor. There is a main level function associated with each thread. This is the entry-level function and is the basic execution level of the thread. All subsequent function calls are made through the main level function.

Each thread requires certain resources like processor time, memory resources, and input/output (I/O) services in order to accomplish its objective. An operating system allocates these resources to various threads. The operating system provides a scheduling service that schedules the thread for running on the processor. In case of a multiprocessor configuration, the scheduling service schedules the thread to run on an appropriate processor. All threads are stored in main memory, which can be directly accessed by the processor. The main memory is a repository of quickly accessible data shared by the processor and the I/O. It is an array of words or bytes, each having its own address. Some data processing systems have a larger but slower memory while others may have a smaller but faster memory. Most of the currently used memory architectures use a heterogeneous memory model, including small, fast memory as well as large, slow memory.

The processor interacts with the main memory through a sequence of instructions that load or store data at specific memory addresses. The speed at which these instructions are executed is termed as the memory speed. Memory speed is a measure of the assistance provided by the memory of a data processing system to multiple ongoing computations within the processors. The time duration taken for memory access depends upon the memory speed available. Data required to complete the instruction being executed is not available to the processor for this time duration. Hence, the processor executing the instructions stalls for this time duration. To accommodate such a speed differential, a memory buffer called a cache is sometimes used in conjunction with the main memory. A cache provides an additional fast memory between the processor and the main memory. A small number of high-speed memory locations in the form of registers are also located within the processor. Relevant data for the execution of a program is stored in the form of stacks and other data structures within the fast memory. Each processor generally has a kernel stack associated with it. This stack is used by the operating system for specific functions such as running interrupts, or running various operating system services.

Each process or virtual thread of execution generally has a program counter, other registers, and a process stack associated with it. Program counters are registers that contain information regarding the current execution status of the process. These registers specify the address of the next instruction to be executed along with the associated resources. The process stack is an execution stack that contains context information related to the process. Context information includes local data, global variables and information pertaining to the activation records corresponding to each function call. Local data consists of process information that includes return addresses, local variables, and subroutine parameters. The local variables are defined during the course of process execution. Besides, certain temporary variables may be created for computation and optimization of complex expressions. Common sub-expressions may be eliminated from such expressions and their value may be assigned to the temporary variables.

The context information defines the current state of execution of the thread. While swapping out of a processor, the active context information pertaining to the thread is stored on the thread's execution stack. In certain systems, a separate memory area is assigned for storing the context of a thread while swapping.

The scheduling service of the operating system manages the execution of threads on the processing system. The scheduling service ensures that all processes gain access to processing resources in a manner that optimizes the processing time. In order to do this the operating system has to, either periodically or when requested, swap the thread running on a particular processor with another thread. This is called thread switching. The operating system maintains a ready queue that sequentially holds threads, which are ready for execution and are waiting for processor resources. A temporarily stalled thread is scheduled back on a processor when it reaches the head of the ready queue.

A thread may voluntarily preempt itself by yielding processor resources and stalling temporarily. This may happen if a desired resource is unavailable or the thread needs to wait for a data signal. Typical preemptive services that may cause a thread to preempt include synchronization mechanisms like semaphores, mutexes, and the like. These services are used for inter-thread communication and coordinating activities in which multiple processes compete for the same resources. For instance, a semaphore, corresponding to a resource, is a value at a designated place in the operating system storage. Each thread can check and then change this value. Depending on the value found, the thread could use the resource or wait until the value becomes conducive to using the resource. Similarly, mutexes are program objects created so that multiple program threads can take turns sharing the same resource. Typically, when a program is started, it creates a mutex for a given resource at the beginning by requesting it from the system. The system returns a unique name or identification for it. Thereon, any thread needing the resource must use the mutex to lock the resource from other threads while using the resource. Another class of preemptive services is related to input-output and file access. Alternatively, a thread may preempt while waiting for a timer signal or a DMA transfer to complete. A thread may also be waiting for receiving access to a special-purpose processor or simply waiting for an interrupt.

Thread switching entails saving the context information of the current thread and loading the context information related to the new thread. This is necessary so that execution of the preempted thread may be resumed later at the point of preemption. The switching time is pure overhead because the system doesn't do any useful work during switching. The speed of switching depends on the processor used. It also depends on the memory speed, the number of registers to be copied and the existence of special instructions. For example, lower thread switching overheads will be involved if a system uses a single instruction to load or store all the registers. The thread switching time typically ranges from 1 to 1000 microseconds.

Thread switching further involves changing the stack pointer to point to the current register set or execution stack associated with the new thread. The stack pointer is a reference means used by the operating system. The stack pointer refers to the address of the register set of the processor on which a given thread needs to be executed next. A separate execution stack needs to be maintained for each thread in the memory. In order to make thread execution and switching faster, the execution stacks may be put in fast local memory. The number of execution stacks that can fit into the fast memory limits the number of threads that can be used.

In case of systems using a cache in conjunction with the main memory, if the number of threads is more than the number of processors, the performance of the system may be impaired during thread switching. Cache congestion may occur due to frequent copying of data to and from the memory resulting from calls to different stacks.

The current state of art provides certain systems that attempt to reduce thread-switching overheads. One such system is described in U.S. Pat. No. 6,223,208, assigned to International Business Machines Corporation, NY, USA, titled “Moving Data In And Out Of Processor Units Using Idle Register/Storage Functional Units”. This patent provides a system that is primarily a hardware-based methodology. This methodology attempts to reduce context switch overheads by hiding the memory latencies involved with other processing. However, it does not actually reduce the amount of active context information that a thread needs to store. Besides, it entails addition of new circuitry to the processors. It applies only to multithreaded processors and not general-purpose single or multiprocessor systems.

U.S. Pat. No. 5,872,963, assigned to Silicon Graphics, Inc. CA, USA, titled “Resumption Of Preempted Non-Privileged Threads With No Kernel Intervention”, provides a system and method for context switching between a first and a second execution entity without having to switch context into protected kernel mode. The system provides a special jump-and-load instruction on the processor for achieving the purpose. However, it only removes the overhead of jumping into kernel mode while switching threads. It does not address the basic problem of overheads related to the actual context load. Besides, the method is only effective and useful in case of voluntary thread yield in a preemptive system.

Moreover, the above systems do not attempt to reduce memory congestion that happen due to repeated calls to execution stacks of different threads. The number of execution stacks that can fit into the fast memory also limits the number of threads that can be used.

In light of the foregoing discussion, there is need for a system and method that reduces the thread switching overheads by reducing the amount of active context associated with a thread. The system should also minimize the local memory usage and congestion in order to free the local memory for other important purposes. The system should be applicable to single as well as multiple processor configurations. A need also exists for a system, which is effective and useful in a preemptive as well as non-preemptive operating system environment.

### SUMMARY

The disclosed invention is directed to a system and method for minimizing thread switching overheads and reducing memory usage during multithreaded application processing.

An object of the disclosed invention is to provide a method and system for efficient multithreaded processing in single as well as multiple processor configurations.

Another object of the disclosed invention is to provide a new kind of thread, called a “floating thread” that is written using a function calling convention, which allows rapid thread switching with minimal switching overheads.

A further object of the disclosed invention is to ensure that the amount of active context associated with a thread is minimal when the thread is swapped out of the processor.

Yet another object of the disclosed invention is to provide a method and system that does not require storage of reference information of a thread while the thread is being swapped.

Still another object of the disclosed invention is to minimize cache congestion during thread switching.

Yet another object of the disclosed invention is to minimize the number of execution stacks for various threads that need to be maintained within the local memory.

In order to achieve the foregoing objectives, and in accordance with the purpose of the disclosed invention as broadly described herein, the disclosed invention provides a new thread programming methodology and a method and system for compiling and executing the same. The application is written using floating threads such that thread switching overheads are reduced. Floating threads are written in such a manner that they do not require reference information to be saved in the main memory when the thread is swapped out of execution. A floating thread compiler is provided for compiling the entry level function of the floating thread.

All preemptive functions are written in the main level and the swapping occurs across this main level only. This ensures minimal context storage and retrieval when a thread is preempted and later resumed. The reference information that a thread needs to be kept persistent across preemptive function calls is stored in fast local memory in the form of thread stores. This reference information is later retrieved when the thread is resumed. There is only one execution stack associated with a processor, which is used as execution stack for all the floating threads to be run on that processor. This minimizes the memory usage and cache congestion during thread switching.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a schematic diagram that illustrates the general structure of a floating thread;

FIG. 2 is a block diagram schematically representing the multithreaded processing environment in which the disclosed invention operates;

FIG. 3 is a block diagram that illustrates the architecture of a floating thread compiler in accordance with an embodiment of the disclosed invention;

FIG. 4A and FIG. 4B schematically illustrate the preemption modules that provide preemptive services to the threads;

FIG. 5 schematically illustrates the various types of functions in a floating thread and the restrictions imposed upon writing such functions;

FIG. 6 is a graphical representation that schematically illustrates the constraint on floating thread functions by way of an example;

FIG. 7 is a flowchart that illustrates the basic process steps occurring during the execution of a thread of the application program;

FIG. 8 is a flowchart that depicts the process steps that occur when a preemptive function is called from a floating thread main level function;

FIG. 9 is a flowchart that depicts the process steps occurring during execution of a preemptive function called from within the main level function of the floating thread; and

FIG. 10 illustrates a typical methodology for writing preemptive functions that use the floating thread preemption service, in conjunction with an example pseudo-code.

### DESCRIPTION OF PREFERRED EMBODIMENTS

The disclosed invention provides a system and method for writing, compiling and executing multiple threads in single as well as multiple processor configurations. In a multithreaded processing environment, switching overheads involved in thread switching limit the number of threads that an application can be split into. In addition, the number of execution stacks that can fit in fast memory also limit the number of threads that can be simultaneously processed. The disclosed invention aims at minimizing switching overheads as well as reducing the number of execution stacks that the threads together use. This is achieved through a “floating thread” structure for programming threads. Threads written using the floating thread structure are referred as floating threads.

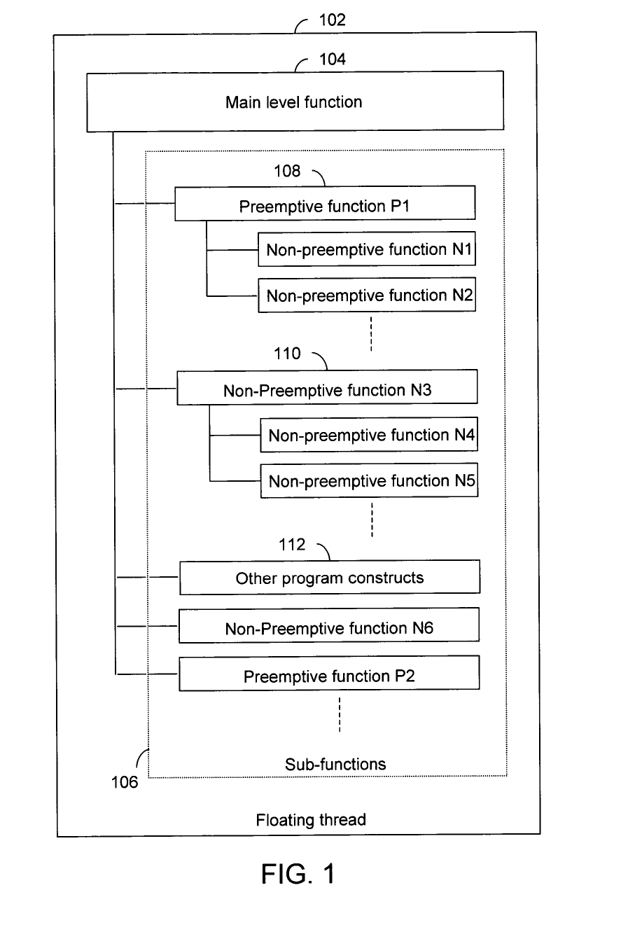

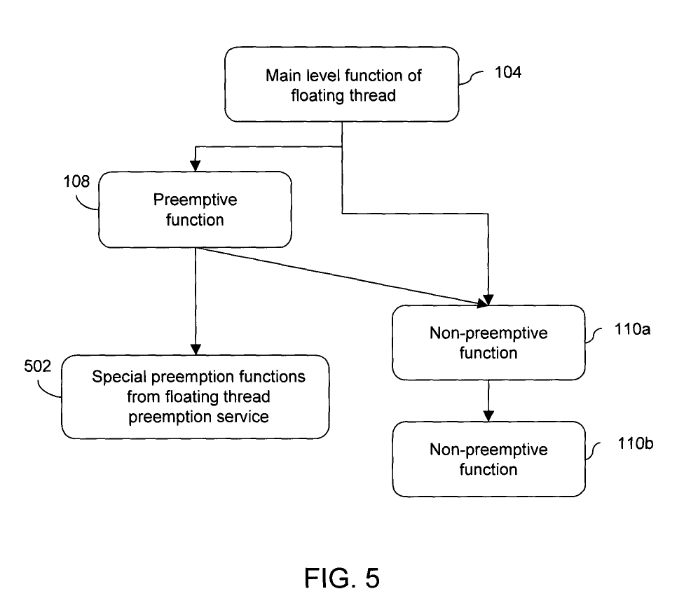

FIG. 1 is a schematic diagram that illustrates the general structure of a floating thread. Floating thread 102 consists of a main level function 104, which is the entry-level function of the thread. This function makes subsequent calls to other sub-functions 106. Sub-functions 106 include preemptive functions 108, non-preemptive functions 110 and other program constructs 112. Preemptive functions 108 are those functions that may temporarily block floating thread 102. Thread synchronization mechanisms and I/O operations are examples of functions that may be preemptive in nature. Non-preemptive functions 110 are normal functions that never block the thread. Examples of non-preemptive functions include program-specific computation functions and non-blocking operating system calls. Sub-functions 106 are written in accordance with a specific function calling convention, which will be described in detail in conjunction with FIG. 5. When compiled and executed in accordance with the methodology of the disclosed invention, the floating thread does not need to save any information in its registers or on its stack while swapping out during execution.

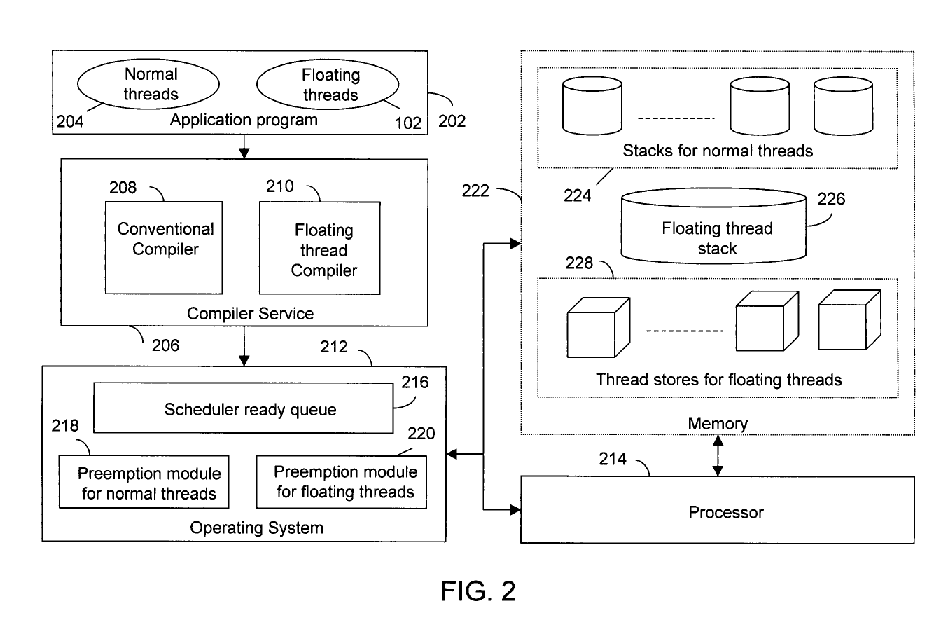

FIG. 2 is a schematic diagram representing the multithreaded processing environment in which the disclosed invention operates. The multithreaded processing environment comprises an application program 202, a compiler service 206, an operating system 212, at least one processor 214 and memory 222. Application program 202 is written as a series of functions and other program constructs using normal threads 204 and floating threads 102. Normal threads 204 are conventional threads, which are written, compiled and executed according to standard thread methodology. The standard thread methodology is well known in the art and is known to those skilled in the art. Floating threads 102 are specially written, compiled and executed in accordance with the method of the disclosed invention. There are certain restrictions with respect to the writing and execution of floating threads, which will be explained in detail in conjunction with FIG. 5.

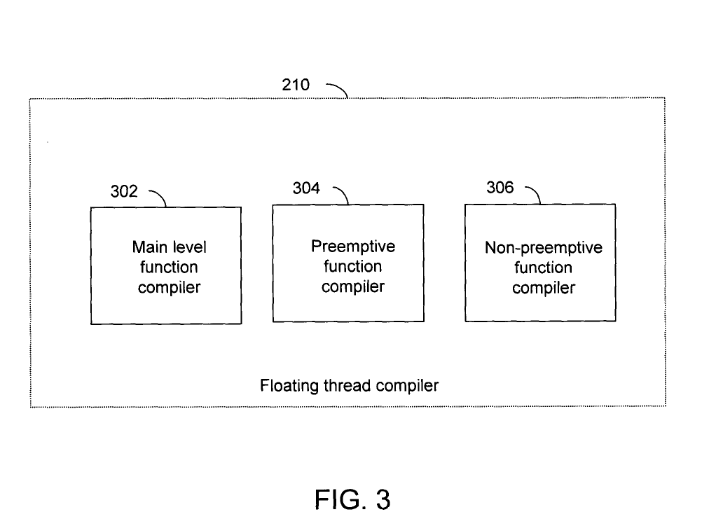

Compiler service 206 compiles application program 202. Compiler service 206 comprises conventional compiler 208 and floating thread compiler 210. Conventional compiler 208 compiles functions comprising a normal or conventional thread. On the other hand, floating thread compiler 210 compiles functions comprising floating threads. The architecture of floating thread compiler 210 will be explained in conjunction with FIG. 3.

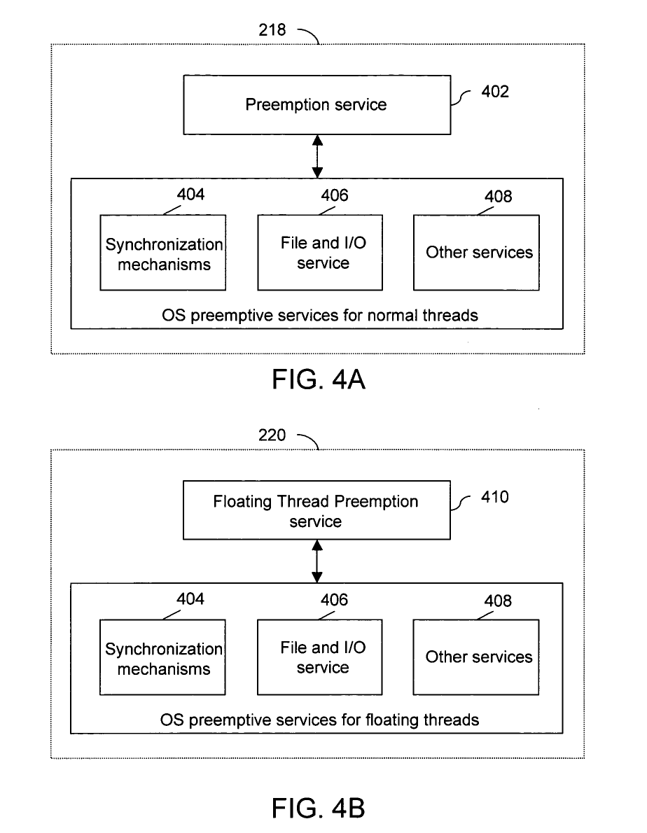

Upon compilation, application program 202 is run by operating system 212 on a computer having one or more processors 214. Operating system 212 manages the scheduling and processing of various threads on processors 214. This involves periodic loading of certain threads on the processors while blocking execution of other threads. This is done via scheduler ready queue 216, which holds normal and floating threads in the ready state. The ready state of the threads implies that these threads are ready for processing and are waiting for allocation of a free processor to them. Threads that need access to an unavailable resource or otherwise need to temporarily stall are preempted and swapped from their respective processors. In other words, these threads give up the processor resources temporarily for another thread to utilize the resources in the meantime. Threads at the head of ready queue 216 then replace these suspended threads. Once a suspended thread is ready for execution, it is added to the tail of ready queue 216. Operating system 212 also provides preemption modules 218 and 220 for providing preemptive services to normal and floating threads respectively. These services will be explained in detail in conjunction with FIG. 4.

In the preferred embodiment of the disclosed invention, operating system 212 is assumed non-preemptive. This means that operating system 212 swaps out a thread only when the thread itself, or a service that the thread calls, on behalf of the thread, asks that the execution of the thread be blocked.

Normal threads 204 are executed by processor 214 according to the standard thread methodology. Activation records of normal threads 204 as well as their context when they swap out are stored on normal thread stacks 224 stored in memory 222. The stacks keep track of various function calls and returns, in addition to storing the required local and global variables. Thus, there is one independent stack for each normal thread 204. Stack sizes are predefined and the number of stacks that may fit into fast local memory limit the number of threads that may be executed.

Execution of floating threads 102, on the other hand, requires only one stack per processor in the computer system. Floating thread stack 226 associated with processor 214 will be used in turns by all the floating threads, which run on processor 214. Once a floating thread is swapped out from a processor, it may be swapped in later on another processor. Even if it is swapped in on the same processor that it ran on earlier, another thread might have run on that processor in the mean while. This implies that the thread cannot assume the persistence of any data that it keeps on floating thread stack 226 while swapping out. Any variable or other state information, which the thread needs to keep persistent across thread swaps, needs to be stored in a memory area called thread store.

Each floating thread has an associated floating thread store 228. The required storage size of thread store is reported by floating thread compiler 210 while compiling the floating thread, as opposed to thread stacks, which have predefined size. According to the reported size, threads are allocated stores by the operating system. Apart from space for temporary variables, the store also has space for saving function parameters. The operating system maintains a floating thread data structure for each floating thread. This data structure holds pointers to thread stores as well as other data required for the operation of a floating thread. Additionally, it has two new fields, one being condition code field, and the other being called function pointer field. Alternatively, space for these two fields may be added to the thread stores. The functionality of these fields will be elaborated upon later in conjunction with the methodology of writing preemptive functions.

FIG. 3 is a block diagram that illustrates the architecture of floating thread compiler in accordance with an embodiment of the disclosed invention. Floating thread compiler 210 comprises main level compiler 302, preemptive function compiler 304 and non-preemptive compiler 306. Main level compiler 302 compiles the entry-level function of a floating thread. This is the execution level of the thread, which makes subsequent preemptive and non-preemptive function calls. Preemptive function compiler 304 compiles various preemptive functions. Non-preemptive complier 306, on the other hand, compiles various non-preemptive functions. In the preferred embodiment of the disclosed invention, the various compilers are combined into a single compiler, which is programmed to implement the appropriate compilation methodology with respect to a function.

FIGS. 4A and 4B schematically illustrate the preemption modules that provide preemptive services to the threads. Preemption module 218 in operating system 212 provides a preemption service 402 to normal threads in accordance with FIG. 4A. Preemption service 402 enables various preemptive services like inter-thread communication and synchronization mechanisms 404 using semaphores, mutexes or mailboxes. Using these services, a thread can wait for a signal or data from another thread. While the signal or data does not appear, the thread is swapped out of the processor, so that the processor resource may be utilized by another thread. Another class of preemptive services is file and input/output (I/O) services 406 wherein access to a resource is governed by a set of criteria. Examples of these criteria include elapsed time for using a resource, priority of task and the like. Other services 408 may also be provided to the threads as required. For instance, a thread can request for preemption while waiting for a timer signal, data transfer, allocation of a specific compute resource or waiting for an interrupt. FIG. 4B illustrates floating thread preemption module 220. Floating thread preemption service 410 enables preemptive services for floating threads. Using floating thread preemption service 410, an application programmer can write specific preemptive services for use in an application, in addition to the conventional preemptive services. These preemptive services include synchronization mechanisms 404, file and I/O service 406 and other services 408.

In order to utilize the floating thread methodology of the disclosed invention, an application programmer needs to abide by certain restrictions while writing an application code. Such restrictions are necessary for ensuring compliance with the compilation scheme used for compiling floating threads. A floating thread is expected to swap out of the processor without the need for storing its context in its registers and stacks. These restrictions ensure that the actual context information that the floating thread needs to save in its thread store is minimal and the size of such persistent context is predictable.

The application code for programming threads is written using an imperative language. In the embodiment of the disclosed invention described hereinafter, such programming is done using C language. However, it would be evident to one skilled in the art that the methodology described herein can be implemented using any other imperative language.

FIG. 5 schematically illustrates the various types of functions comprising a floating thread and the restrictions imposed upon writing such functions. Main level function 104 of the floating thread is the entry function of the thread and is the basic execution level. Main level function 104 is allowed to use all C language constructs and make function calls. The functions that main level function 104 calls are classified into two classes, namely preemptive functions 108 and non-preemptive functions 110.

Preemptive services are called using preemptive functions 108. Preemptive function 108 is allowed to use all C language constructs and to make other function calls, but these function calls can only be to other non-preemptive functions 110. A preemptive function is not allowed to call other preemptive functions. A preemptive function can call special functions 502 from the floating thread preemption service, which causes the function to preempt and restart.

Non-preemptive functions 110 are allowed to use all C language constructs and make other function calls. However, these function calls can only be to other non-preemptive functions. A non-preemptive function 110a can only call another non-preemptive function 110b as shown in FIG. 5. It is not allowed to call preemptive function 108. Thus, the only functions, which can call preemptive functions 108, are the thread main level functions 104.

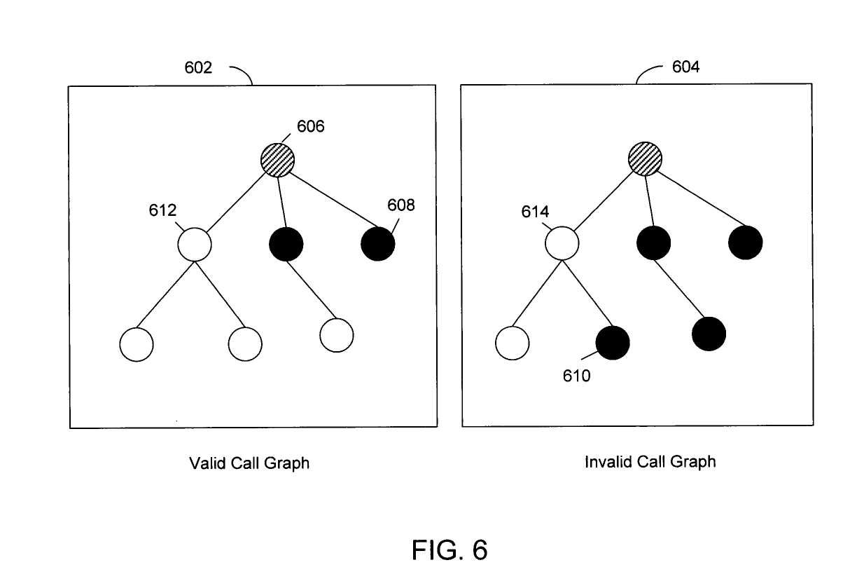

FIG. 6 is a graphical representation that schematically illustrates the constraint on floating thread functions by way of an example. Call graph 602 represents a valid call sequence, while call graph 604 represents an invalid call sequence. Hashed circles 606 represent the main level function. Filled circles 608 and 610 represent preemptive functions while blank circles 612 and 614 represent non-preemptive functions. All preemptive functions are required to be called in the main level as shown in valid call graph 602. A preemptive function cannot be called in a non-preemptive function as shown in invalid call graph 604. Further, a preemptive function cannot be called in a preemptive function, as shown in invalid call graph 604.

Compiler service 206 makes sure that the above-mentioned restrictions are met by the application code. In one embodiment of the disclosed invention, the restrictions can be imposed by enforcing use of specific keywords for function declaration in application code. The programmer uses specific keywords in the declarations of preemptive functions and floating thread main level functions. For instance, the keyword “preemptive” may be used with preemptive functions, while the keyword “floating” may need to be used with the main level functions. All other functions are then assumed to be non-preemptive functions.

Using such descriptive declarations of functions, the compiler can enforce the above function calling restrictions. Since the compilation techniques used for each of these types of function are slightly different, such declarations would also be helpful for the compiler to use the correct compilation technique.

In an alternative embodiment, the compiler itself distinguishes between preemptive and non-preemptive functions by seeing which functions call floating thread preemption service 310. The “floating” keyword for main level functions is still required.

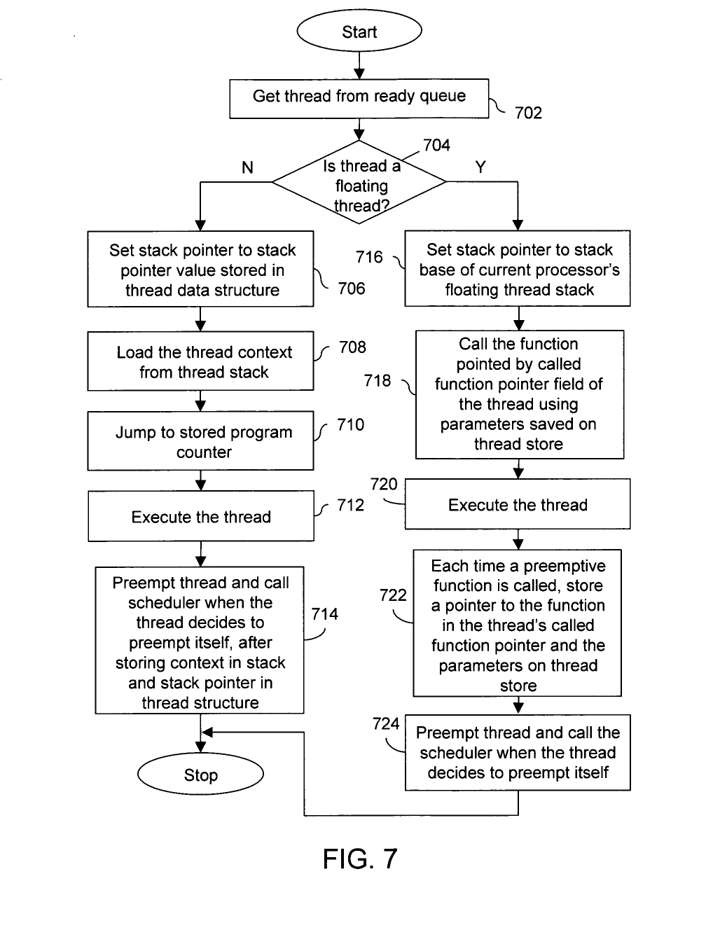

The methodology of writing a preemptive function to preempt a floating thread is different from the methodology of writing a function to preempt a normal thread. In case of a normal thread, standard preemption service 302 provided by operating system 212 preempts a thread and restarts it at the same point of execution and state that it was preempted in. Floating thread preemption service 310 works differently. Floating thread preemption service 310 preempts the thread, but after the thread is resumed, the control flow returns to the beginning of the preemptive function which called the preemption service, instead of the point at which the preemption service was called. This is done using the called function pointer field in the thread's data structure. This field stores a pointer to the function that earlier called the preemption service. The state of the function activation record is also rolled back to the state it was in at the beginning of the function. This is useful because the context at the entry of a function is minimal and predictable. These aspects of the disclosed invention will be further elaborated upon in conjunction with FIG. 7.

A special condition code field is provided in the thread structure of the floating thread, as mentioned earlier, so that a preemptive function can distinguish between the first and successive calls to it. This condition code field is set to a specific field value such as NEW every time a floating thread calls a preemptive function. The condition code field is not touched by the floating thread preemption service, so that if the preemptive function itself changes the condition code before preemption, then the changed condition code field is visible to the preemptive function when the function is restarted after the preemption. This is useful for ascertaining the current state of the function.

FIG. 7 is a flowchart that illustrates the basic process steps occurring during the execution of a thread of the application program. At step 702 a ready thread is selected from the ready queue by the scheduler for loading onto one of the free processors. At step 704 it is ascertained whether the thread is a normal thread or a floating thread. If the thread is a normal thread then the processor needs to load the thread context in order to resume its execution. At step 706 the processor's stack pointer is pointed to stack pointer value stored in the thread's data structure. The stack thus pointed is the stack associated with the loaded thread, and stores the context information required for further processing of the thread.

At step 708, the thread context is loaded from the thread stack pointed at step 706. The context includes a pointer to the program counter, which is a register containing the address of the next instruction to be executed. At step 710, the processor jumps to the stored program counter. The thread is executed from the point it was preempted at step 712. If at any stage the thread requests preemption, the entire thread context is stored in its stack and the stack pointer is stored in the thread data structure. Thereafter the thread is preempted and the thread yields control to the operating system scheduler, in accordance with step 714, so that the resource may be allocated to another thread.

However, in case the thread is ascertained to be a floating thread at step 704, then the thread doesn't have an associated stack. Each processor has a single floating thread stack associated with it, as explained earlier. At step 716, the processor's stack pointer is pointed to the stack base of the processor's floating thread stack. If the thread running previously on that processor was a floating thread too, the stack pointer would already be pointing to base of this processor's floating thread stack, so it need not be changed.

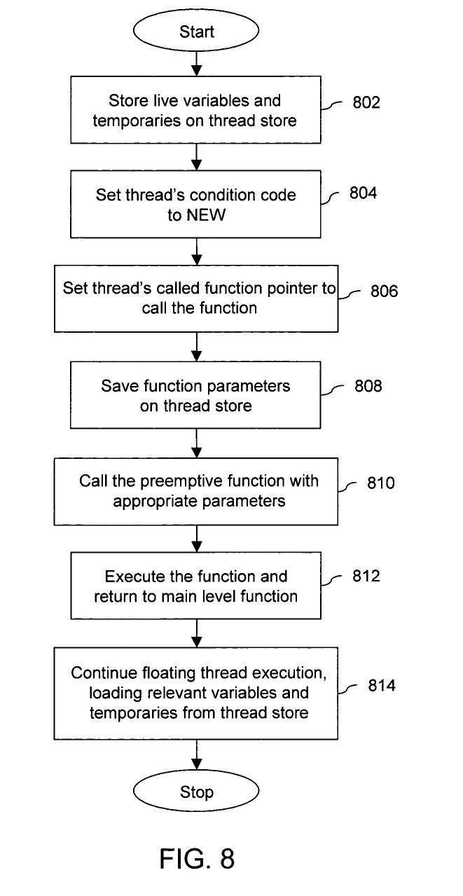

At step 718 the parameters stored in the thread store are retrieved. The function pointed by the called function pointer field of the thread is called using the retrieved parameters, as mentioned earlier. Execution of the thread resumes at the main level function of the thread from the function that had earlier called the preemption service, in accordance with step 720. As soon as a preemptive function is called, at step 722, a series of operations are performed by the operating system. A pointer to the function is stored in the called function pointer field and important parameters are stored on the thread store. The process steps that occur in response to a call to a preemptive function will be further explained in detail in conjunction with FIG. 8. When the floating thread preempts at step 724, it directly yields control back to the operating system scheduler, without saving any context information for the thread. The scheduler subsequently selects a new ready thread for execution.

In an embodiment of the disclosed invention, floating thread compiler 210 is a standard C compiler. For standard C language constructs, the compiler behaves in a standard manner. However, while calling non-preemptive functions, this compiler uses the calling convention of the standard compiler, which is compiling that function. The compiler compiling the preemptive or non-preemptive function may not be same as the compiler compiling the floating thread, as explained earlier in conjunction with FIG. 3. For instance, this functionality may be achieved through compilers 304 and 306. However, in the preferred embodiment, the entire compilation functionality is embodied in the floating thread compiler 210. While calling preemptive functions, the compiler performs certain storing and updating operations. These operations have been elaborated upon in conjunction with FIG. 8.

FIG. 8 is a flowchart that depicts the process steps that occur when a preemptive function is called from a floating thread main level function. These steps represent the code produced by floating thread compiler 210 in response to a preemptive function call. At step 802, all live local variables and temporaries are stored in the thread's store. Live variables are the variables having been defined and assigned values earlier, and subsequent instructions would need to access these values. This is required because if the call to the preemptive function causes the thread to preempt, then it is likely that all the contents of the thread registers as well as the stack may be overwritten.

For local variables and temporaries that do not need to be persistent across preemptive function calls, the compiler may allocate space on the stack, or in the processor's registers. These may subsequently be used during the execution of the function. For variables and temporaries that are live across function calls, the persistence is provided by the thread store. At step 804, the thread's condition code field is set to NEW, in accordance with the methodology of writing preemptive functions as explained earlier. This value indicates that the thread hasn't been preempted earlier.

At step 806, the called function pointer field in the floating thread data structure is set to point to the memory address of the preemptive function being called. At step 808, the parameters that the function is going to be called with are saved on the thread's store. The function pointer and function parameters are saved so that if the thread is preempted, it can restart from the beginning of the preemptive function, in accordance with the methodology of writing preemptive functions as explained earlier.

At step 810, the preemptive function indicated in the floating thread main level function code is called with the appropriate parameters. Here, the calling convention of the compiler compiling preemptive functions needs to be used. For instance, the compiler may expect the function parameters in a few designated registers, or on the stack. In an embodiment of the disclosed invention, a standard C compiler does the compilation of the floating thread. Such a compiler has a standard pre-determined function calling convention, which then needs to be followed. In such a case, appropriate parameter setup would be required prior to calling the function.

In an alternative embodiment, where a special compiler is used for compiling the preemptive function, the compiler functionality can be augmented to read the function parameters from the thread store directly. In such a case parameter setup need not be performed since the function parameters are already stored on the thread store at step 808.

In order to call a preemptive function, the floating thread stack on the corresponding processor also needs to be setup. This stack would be used by the preemptive function for its activation record and the activation records of functions it calls. Before calling the preemptive function, the activation record of the main level function is on the stack. The compiler assumes that this activation record does not remain persistent across the preemptive function call. Hence, the activation record of the preemptive function can overwrite the activation record of the main level function.

The stack pointer continues to point to the same base of the stack that the main level function was running on. Keeping the stack pointer stationary is necessary. This is because when the preemptive function is restarted, the stack is setup by the operating system, and not the floating thread main level function. This stack is set up to start from the stack base of the floating thread stack. Thus, in order to maintain consistency, the floating thread main level function should also setup the stack for the preemptive function in a similar manner.

In an alternative embodiment, the entire activation record of the main level is not overwritten. In case some part of the main level activation record needs to be kept active for the parameters or the return value, the OS is intimated the offset from the floating thread stack base that the preemptive function activation record is to be started from.

In order to call the preemptive function at step 810, there may be certain other requirements apart from those mentioned above. For instance, the functions require return addresses to be available either in a particular register or on stack. The return address needs to be kept persistent, because the same preemptive function could be called from more than one points in a floating thread, or from more than one floating threads. Therefore, the return address is recorded on the thread store too. When the operating system restarts the preemptive function, it can setup the return address for the function using information recorded on the thread store. Some processors provide special CALL instructions to call functions, which automatically record the return address, generally in a register. If this instruction is used, then preemptive function compiler 304 or floating thread compiler 210 in the preferred embodiment is augmented to store the return address on the store. Alternatively, the address of the CALL instruction itself can be stored on the store. While restarting the preemptive function, the operating system can make a jump to the CALL instruction.

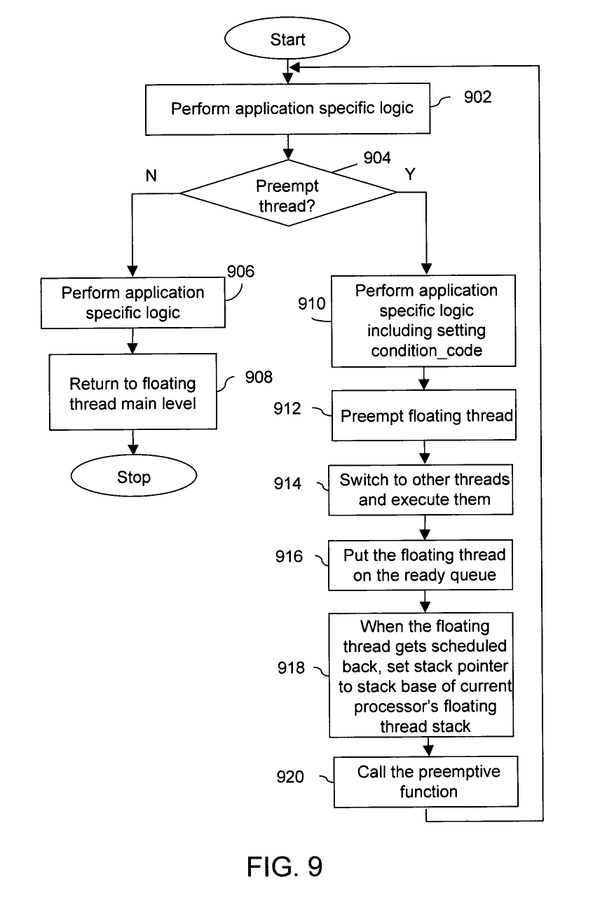

After having setup function parameters, stack pointer and any other requirement of the calling convention, as explained above, the code produced by floating thread compiler 210 will cause a jump to the appropriate preemptive function. The called function is executed at step 812. The step of execution of the called function will be explained in detail, in conjunction with FIG. 9. At step 814, the function control returns back to the main level function. This may happen either directly or after the function has been preempted and restarted. Further instructions in the floating thread main level function are then executed.

In case any variables or temporaries generated before the preemptive function call are needed, they have to be loaded from the thread store. The compiler makes use of a pointer pointing to the base of the store, called the store pointer, to store and load the persistent data objects. These data objects, i.e. variables and temporaries are allocated space at different memory offsets relative to the store pointer. The store pointer is provided directly in a register for the use of the compiler. Alternatively, it may be stored as a field in the thread data structure. In such a case a thread data structure pointer is available to the compiler.

The compiler does optimizations in order to minimize the size of the store. For example, if two data objects are never live together during any one preemptive function call, the compiler may allocate them at the same offset in the store. Besides, the space held by temporary variables may also be optimized. For evaluation of complex expressions, common sub-expressions are usually calculated prior to the entire function evaluation and their values are assigned and stored as temporary variables. These temporary variables might need to be accessed across preemptive function calls. A temporary variable generated due to common sub-expression elimination may not be kept live across preemptive function calls. The expression can be recalculated after the call. Alternatively, the cost of recalculating the sub-expression may be weighed against the cost of requiring extra store space, in accordance with application-dependant cost functions.

The compiler reports the size of the store required for any particular thread. This information is used to allocate the thread stores, preferably in fast local memory. According to the specific requirements of the operating system and application, this information maybe needed at compile time, link time or run time. If the information is required at compile time then a special keyword like size_of_store used as size_of_store (main_level_function_name) is provided. If the information is required after the compilation, it maybe stored in a separate file, which can then be used by the linker or loader.

FIG. 9 is a flowchart that depicts the process steps occurring during execution of a preemptive function called from within the main level function of the floating thread. At step 902, the processor performs the specific logic as described by the preemptive function code. In accordance with step 904, the function decides whether to preempt the thread or to return to the main level function, based on the processed logic and existing conditions of resource availability etc. In case the thread doesn't need to be preempted, application specific logic is performed at step 906. At step 908, the function call returns control back to the main level floating thread function.

However, if the thread needs to be preempted, the condition code field of the thread is changed by the preemptive function at step 910. The thread is then preempted at step 912. This may be done through a pre-defined call to the operating system. This call is provided by the floating thread preemption service. Once the floating thread is preempted, the operating system switches to other threads and executes them at step 914. Eventually, at step 916 another thread or a logical entity like an event handler or an interrupts handler wakes up the preempted thread by putting it back on the ready queue. The operating system finally allocates one of the processors to the thread.

In order to resume thread execution, the operating system sets up the stack for the floating thread at step 918 as explained earlier in conjunction with FIG. 7. This is done by making the processor's stack pointer point at the base of the floating thread stack corresponding to the processor. At step 920, the preemptive function is called. The operating system sets up all necessary conditions and parameters pertaining to the preemptive function compiler's calling convention. Relevant information including various parameters and return addresses is loaded from the associated thread store. Other data like thread pointer and store pointer may be setup if necessary.

Next, the preemptive function is restarted by jumping to it directly, using the address stored in called function pointer field of the thread's data structure. In an alternative embodiment, where a pointer to a CALL instruction is stored, as explained earlier, the jump is made to the call instruction instead. The preemptive thread then resumes its execution. Based upon the application logic and other conditions, it again decides whether to preempt further or return to the floating thread main level function.

The floating thread methodology of the disclosed invention provides significant time and memory optimization. When a floating thread preempts, it is swapped right away with another thread, without the need of storing the entire thread context stored in its stacks and registers. The time taken in loading and storing the thread context is saved. This gives significant improvement when a processor has a large context associated with it. Instead of storing the entire context, only information pertinent to the thread is stored. The compiler allocates this space since the compiler knows exactly the amount of context that needs to be persistent at any point in the thread.

The memory footprint improvement caused due to minimization of context memory is useful both in case of local memory systems as well as cache systems. It is also useful in the case when only a very small amount of memory is available to the program.

Furthermore, since all floating threads use the same stack on a processor, the overall memory requirement is reduced. This functionality can be used to free up local memory for other important purposes. In case of cached systems, this results in minimization of cache congestion that would otherwise happen due to repeated thread switching and usage of different stacks.

In an alternative embodiment, each thread uses its own stack. The improvements relating to context loads and stores still apply. If each thread is using its own stack, then stores are not necessary. The context can be saved into and loaded from the stack itself.

The methodologies described in this patent are also applicable to preemptive operating systems. In a preemptive operating system, a thread yielding on its own can be blocked and restarted using the floating threads methodology, whereas whenever it gets preempted due to external circumstances the context will have to be saved and loaded like a normal thread. If a floating thread is being preempted due to external circumstances, the state of the floating thread stack will have to be copied too. This is not applicable if the floating threads are using their own stacks.

In order to illustrate the methodology of writing floating thread applications under the restrictions described earlier, a series of exemplary pseudo-codes are hereinafter described. These pseudo-codes have been provided for the purpose of illustrating and not limiting the use of floating threads.

Following is an example pseudo-code illustrating two threads in a producer-consumer configuration.

```
floating producer ( )
{
    for (;;)
    {
        wait (semaphore_finished);
        produce_item ( );
        post (semaphore_ready);
    }
}
floating consumer ( )
{
    for (;;)
    {
        wait (semaphore_ready);
        consume_item ( );
        post (semaphore_finished);
    }
}
```

The functions producer and consumer are the main level functions of the producer and consumer threads. This implies that these functions are the first functions being called by the operating system when it starts running the respective threads. If the semaphore semaphore_finished is started with a value of 1, and the semaphore semaphore_ready is started with a value of 0, then the above pseudo-code would cause alternation between the producer and the consumer threads.

The wait function in the above pseudo-code is a preemptive function since if the semaphore value is 0 at the time of the call, the thread is preempted. This function is typically provided in the operating system. The application developer himself writes the produce_item and consume_item functions, according to the application logic being followed by the application. In this example, these functions are non-preemptive, and cannot call preemptive functions or the floating thread preemption service post is also a non-preemptive function, which would be typically provided in the operating system.

Since all the preemptive functions are called at the main level, the above is a valid example of the use of floating threads, illustrating its usefulness. Similarly, thread structures exhibiting a combination of functional parallelism (a pipeline of threads strung together in producer-consumer fashion) as well as data parallelism (threads performing similar functions on different data) can be programmed very well under the restrictions mentioned earlier.

In the example given above, most of the specific application logic goes into the function calls produce_item and consume_item. These functions make use of the stack for their activation records. There would possibly be a lot of context during the execution of a function, but the live context across the preemptive function wait is minimal. The brevity of the live context is exploited successfully by using floating threads.

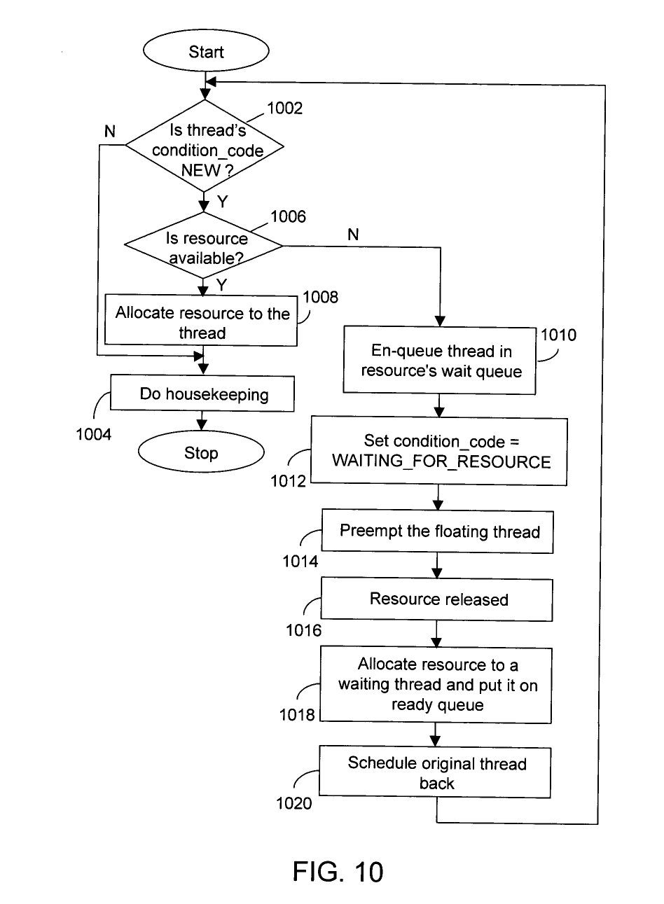

FIG. 10 illustrates a typical methodology for writing preemptive functions that use the floating thread preemption service, in conjunction with the pseudo-code given below. The floating thread preemption service can only be called from a preemptive function, which in turn can only be called from the floating thread main level function.

The following exemplary pseudo-code represents the way a preemptive wait for a resource is written for a floating thread using a preemptive function.

```
preemptive wait_for_resource ( )
{
    if (condition_code for this thread == NEW)
    {
        if (resource is available)
        {
            allocate resource to this thread;
        }
        else
        {
        enqueue thread in resource's wait queue;
        condition_code for this thread =
                WAITING_FOR_RESOURCE;
        preempt_floating_thread ( );
        }
    } //resource has been allocated at this point
  do housekeeping;
}
```

If the resource is not available at the time of execution of the above function, then it is allocated to the thread later by some other entity (like another thread or an interrupt service routine) when the resource becomes available. Such entity runs the following pseudo-code.

```
event that resource becomes available ( )
{
    t = dequeue first thread from the wait queue
            of the resource;
    allocate resource to t;
    enqueue t in scheduler's ready queue;
}
```

This is exactly the same routine that the aforementioned queuing entity would execute in the case of t being a normal (non-floating) thread. The queuing entity need not know whether the thread, which performed the wait on the resource, was a normal or a floating thread.

The above code is consolidated and illustrated through FIG. 10. A preemptive function wait_for_resource requests access to a resource. At step 1002, the thread's condition code field is checked. If the value of condition code field is not NEW, then it implies that the function is not being executed for the first time and it has already been allocated the requested resource. Hence, subsequent processing is continued by the preemptive function at step 1004. However, if the value of condition code field is NEW, then it implies that the function is making a fresh request for the resource. At step 1006 it is further checked whether the requested resource is available. If the resource is available, it is allocated to the thread at step 908. If the resource is not available, then the thread is queued in the resource's wait queue at step 1010. At step 1012, the value of the thread's condition code field is changed to WAITING_FOR_RESOURCE. Next the floating thread is preempted at step 1014.

In the meantime, the operating system runs other threads until a thread or event handler releases the resource at step 1016. Next, at step 1018 the first thread from the resource's wait queue is de-queued. It is allocated the resource and put in the scheduler ready queue. Eventually, at step 1020, the operating system schedules the original thread back in. Since this is a floating thread, the operating system jumps directly to the checked. Since it is not new, the thread continues with the housekeeping as explained earlier. Finally control is returned back to the main level function, which called the preemptive function.

Henceforth another example of the methodology of writing preemptive functions will be described in conjunction with an exemplary pseudo-code. The example illustrates one particular way of using the condition code field. In the following pseudo-code, the function wait_for_event 0 waits for one among a set of specified events, and returns an identifier corresponding to the event that actually occurred. The call is implemented as follows.

```
preemptive wait_for_resource ( )
{
    if (condition_code for this thread == NEW)
    {
        enqueue thread in event set wait queue;
        preempt_floating_thread ( );
    }
    return condition_code for this thread;
}
```

When the thread calls the above function, it causes the thread to be preempted. When an event occurs, the thread is restarted with a changed condition code field. This changed condition code field helps the preemptive function in identifying if it had already preempted itself, as well as the event that caused the thread to restart. The event handler runs the following pseudo-code.

```
event_handler (event_id)
{
    for (t = every thread in event set wait queue)
    {
        condition_code of t = event_id;
        enqueue t in scheduler's ready queue;
    }
}
```

Hence, the condition code field may be exploited in a variety of ways to ascertain the current state of the function.

As another example of writing preemptive functions, the following pseudo-code defines a function, which waits for a resource if the resource is not available. When the resource becomes available then the function does a DMA (Direct Memory Access) transfer (blocking the thread while the DMA is in progress) and then returns. This pseudo-code illustrates multiple uses of the preemption service in a single preemptive function call.

```
preemptive wait_and_transfer (resource r, src, dest)
{
    switch (condition_code of this thread)
    {
        case NEW:
        if (r is available)
        {
            allocate r to this thread;
        }
        else
        {
            enqueue thread in r's wait queue;
            set condition_code for this thread =
                WAITING_FOR_RESOURCE;
            preempt_floating_thread ( );
        }
        case WAITING_FOR_RESOURCE:
        set condition_code for this thread =
                WAITING_FOR_DMA_TRANSFER;
        enqueue thread in dma engine's wait queue;
        initiate DMA transfer from src to dest;
        preempt_floating_thread ( );
        case WAITING_FOR_DMA_TRANSFER:
    }
}
```

The pseudo-codes described above illustrate different ways the floating thread preemption service may be used to program preemptive functions providing various functionalities. It would be evident to one skilled in the art that these pseudo-codes have been provided only to illustrate various methodologies of using the floating thread preemption service under the restrictions of the disclosed invention, and in no way constrain the use of floating threads.

In an embodiment of the disclosed invention, the floating thread preemption service functions, instead of being directly called from a preemptive function, may be called inside a hierarchy of functions called by the preemptive function. However, such functions should be compiled inline. This would provide better functional abstraction, so that a large preemptive function need not be written as a single huge function.

In an alternative embodiment of implementing the floating thread functionality, the restriction of calling the floating thread preemption service directly from the preemptive function may be relaxed. Intermediate preemptive functions may be called from the preemptive function, which in turn calls the preemption service. After the preemption though, the control returns to the preemptive function itself, and not to the intermediate functions. This just requires augmenting the compiler to recognize intermediate preemptive functions and the relaxed restrictions. This enhancement would be useful in obtaining better functional abstraction and reuse of functionality. For example, if an application programmer wants to write a combination preemptive function, which waits on a semaphore and then on another semaphore, it could be written as follows.

```
preemptive combination_wait (sem1, sem2)
{
    switch (condition_code of thread)
    {
        case NEW: intermediate_wait (sem1, WAIT1);
        case WAIT1: intermediate_wait (sem2, WAIT2);
        case WAIT2:
    }
}
preemptive_intermediate intermediate_wait (sem, cond)
{
    if (sem is available)
    {
        down (sem);
    }
        else
    {
        add thread to sem's wait queue;
        set thread's condition_code to cond;
        preempt_floating_thread ( );
    }
}
```

Furthermore, standard functionality like the intermediate_wait function above could be provided in the operating system. For the programmer of combination_wait, the function intermediate_wait is a function that will preempt combination_wait optionally. In this case combination_wait will be restarted from the top, with the condition code set to cond, which the programmer of combination_wait is allowed to specify. Such functions for various kinds of resources can be part of the standard set of functions provided in the floating thread preemption service.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

1. A floating thread structure for programming threads within a multithreaded application program, the floating thread structure minimizing thread switching overheads and memory usage during execution of the multithreaded application program, the floating thread structure comprising:
a. a main level function, the main level function being the basic execution level function for the thread, the main level function making subsequent calls to all other functions; and
b. sub-functions within the main level function, the sub-functions following a function calling convention, the sub-functions comprising:
i. non-preemptive functions, the non-preemptive functions being normal functions that do not stall the thread at any stage of execution, the non-preemptive functions being called from the main level function or any sub-function called by the main level function, the non-preemptive functions being capable of making calls to other non-preemptive functions only;
ii. preemptive functions, the preemptive functions being functions that may cause a thread to temporarily stall further execution, the preemptive functions being called from the main level function only, the preemptive functions being capable of making calls to other non-preemptive functions only; and
iii. other standard program constructs relevant to the thread.

2. The floating thread structure as recited in claim 1 wherein each function definition is preceded by a keyword declaration, the keyword declaration distinguishing amongst main level function, preemptive functions and non-preemptive functions.

3. A method for programming a multithreaded application program using floating threads, the floating threads being threads that do not require saving context information during thread switching, the method comprising:
a. writing a main level function for each floating thread, the main level function being the basic execution level function for the thread, the main level function making subsequent calls to all other functions; and
b. writing sub-functions of the main level function in accordance with a function calling convention, each sub-function being called by the main level function, the writing of sub-functions comprising:
i. writing non-preemptive functions, the non-preemptive functions being normal functions that do not stall the thread at any stage of execution, the non-preemptive functions being called from the main level function or any sub-function called by the main level function, the non-preemptive functions being capable of making calls to other non-preemptive functions only;
ii. writing preemptive functions, the preemptive functions being functions that may cause a thread to temporarily stall further execution, the preemptive functions being called from the main level function only, the preemptive functions being capable of making calls to other non-preemptive functions only; and
iii. writing other program constructs relevant to the thread.

4. The method as recited in claim 3 wherein the preemptive function is written in a manner that the function restarts from its beginning if it preempts the thread.

5. The method as recited in claim 4 wherein writing the preemptive function further comprises:
a. ascertaining the state of the thread, the thread state being ascertained by checking the value of the condition code for the thread, the condition code being a special field associated with the thread, the value stored in the condition code field being indicative of the thread state;
b. performing application specific logic in accordance with the preemptive function;
c. ascertaining whether the function needs to preempt the thread, the ascertaining being based upon the condition code and other application specific logic; and
d. preempting the thread in case the function needs to preempt the thread, the preemption being done after setting the condition code to an appropriate value and performing other application specific logic.

6. The method as recited in claim 3 further comprising declaring a keyword before each function definition, the keyword declaration distinguishing amongst main level function, preemptive functions and non-preemptive functions.

7. A method for minimizing thread switching overheads and number of execution stacks used by threads in multithreaded processing, the method comprising:
a. compiling the threads in accordance with a function calling format, the function calling format ensuring that the thread need not save large context information during thread switching; and
b. executing the compiled application code.

8. The method as recited in claim 7 wherein compiling the threads in accordance with the function calling format comprises:
a. compiling a main level function, the main level function being the basic execution level function of the thread, the main level function making all subsequent calls to other functions;
b. compiling non-preemptive functions, non-preemptive functions being normal functions that do not stall the thread at any stage of execution, the non-preemptive functions being called from the main level function or any sub-function called by the main level function, the non-preemptive functions being capable of making calls to other non-preemptive functions only;
c. compiling preemptive functions, the preemptive functions being those functions that may cause a thread to temporarily stall and yield control to the operating system, the preemptive functions being called from the main level function only, the preemptive functions being capable of making calls to other non-preemptive functions; and
d. compiling other program constructs.

9. The method as recited in claim 8 wherein compiling the main level function comprises:
a. providing instructions for calling a preemptive function comprising:
i. providing instructions for storing and updating operations in response to the preemptive function call, the operations being performed so that the necessary context information pertaining to the thread is not lost if the thread is preempted during the preemptive function call;
ii. providing instructions for enabling the preemptive function to distinguish between the first and subsequent calls to it, the subsequent calls being made in case the preemptive function preempts the thread;
iii. providing instructions for facilitating switching back of the thread, the switching back being necessary in case the preemptive function call preempts the thread, the facilitating being done in such a manner that the thread is restarted from the beginning of the preemptive function during a subsequent call; and
iv. providing instructions for calling the preemptive function with appropriate parameters; and
b. providing instructions for other program constructs and non-preemptive function calls.

10. The method as recited in claim 9 wherein providing instructions for storing and updating operations in response to a preemptive function call comprises:
a. providing instructions for storing all live local and temporary variables on local memory, the live variables being those variables that have been defined and assigned a value prior to the preemptive function call, the values so defined being used after the preemptive function call; and
b. providing instructions for loading the values assigned to the live variables from the local memory when they are required for subsequent execution of the main level function.

11. The method as recited in claim 9 where providing instructions for enabling the preemptive function to distinguish between its first and subsequent calls comprises providing instructions for initializing the thread's condition code, the condition code being a special field associated with the thread used for ascertaining the thread state, the initial value assigned to the field being indicative of the fact that the thread has not been preempted as yet due to the ensuing instance of the preemptive function.

12. The method as recited in claim 9 wherein providing instructions for facilitating the switching back of the thread comprises:
a. providing instructions for setting called function pointer of the thread to point to the preemptive function being called, the called function pointer being a special pointer associated with the thread, the pointer being subsequently used to point at the function that caused the thread to preempt;
b. providing instructions for saving parameters related to the function call in memory; and
c. providing instructions for setting up an executing stack for the preemptive function, the execution stack being needed for maintaining the activation records related to the preemptive function, the setting up of the stack being done in a manner such that an equivalent stack can be set up during switching back of the thread.

13. The method as recited in claim 8 wherein compiling the preemptive function call comprises providing instructions for using the same stack as used by the main level function, the stack being overwritten during the preemptive function call, overwriting of the stack having been facilitated by storing all pertinent information residing on the stack during compilation of main level function.

14. The method as recited in claim 7 wherein executing the compiled thread comprises:
a. setting up the thread for running;
b. running the thread by executing compiled code;
c. preempting the thread and switching to other threads when the thread requests preemption, the preemption being done without saving any context information, the context information being pertinent information associated with the thread; and
d. restarting the preempted thread when the thread is scheduled back for running, such restarting being done with a minimum amount of loading of context information.

15. The method as recited in claim 14 wherein the step of setting up the thread comprises:
a. setting up the execution stack for the activation records of the main level function and other functions within the thread, the thread stack capable of being overwritten during the execution of the thread; and
b. calling the main level function of the thread.

16. The method as recited in claim 14 wherein the step of restarting the thread comprises:
a. setting up the execution stack for execution of the preemptive function that caused the thread to preempt, the setting up being done in a manner such that the subsequent execution of the thread may continue on the same stack, the setting up being done to make minimal use of memory; and
b. calling the preemptive function that caused the thread to preempt, the call being made from the beginning of the function, the calling being facilitated by the main level function having saved all information pertinent to the restarting of the preemptive function.

17. A multithreaded application processing system for executing a multithreaded application program, the program comprising a plurality of normal and floating threads, the normal threads having been written using standard thread methodology, the floating threads comprising a main level function and other sub-functions, the main level function being the basic execution level function making calls to other sub-functions, the sub-functions comprising preemptive and non-preemptive function calls, the sub-functions having been written using a function calling convention that ensures minimal thread switching overheads and reduced memory usage during application execution, the system comprising:
a. a compiler service compiling the application program, the compiler service using separate compilation methodologies for normal and floating threads;
b. a memory storing information related to the threads, the memory being allocated to the threads in a manner so as to minimize memory usage across thread switches;
c. a processor processing the plurality of threads, the processor accessing the memory for information pertaining to the plurality of threads; and
d. an operating system scheduling and managing execution of the plurality of threads, the operating system swapping floating threads without requiring to save reference information pertaining to the floating threads each time these threads are switched into and switched out of the processor in order to minimize the thread switching overheads.

18. The system as recited in claim 17 wherein the compiler service compiling the application program comprises:
a. a compiler compiling normal threads in accordance with the standard methodology for compiling threads; and
b. a floating thread compiler compiling floating threads in a manner such that no reference information needs to be stored on the processor when the floating thread is swapped out of the processor and subsequently swapped back into the processor.

19. The system as recited in claim 18 wherein the floating thread compiler comprises:
a. a main level function compiler compiling entry level function of the floating thread, the entry-level function being the basic execution level function that makes subsequent function calls;
b. a preemptive function compiler compiling functions that are preemptive in nature, the preemptive functions being those functions that may cause a thread to temporarily stall and yield control back to the operating system; and
c. a non-preemptive function compiler compiling function calls that are non-preemptive in nature, the non preemptive functions being those functions that cannot stall the thread at any stage of execution.

20. The system as recited in claim 17 wherein the memory allocated to normal and floating threads comprises:
a. a plurality of normal thread stacks, each of the normal thread stacks being associated with a normal thread, the stack being stored with context information pertaining to the thread, the context information being the entire information set relevant to the thread;
b. a plurality of floating thread stores, each of the thread stores being associated with a floating thread, the thread stores being stored with minimal context information that needs to be kept persistent across a floating thread switch; and
c. a floating thread stack associated with the processor, the floating thread stack being used by the floating thread being processed by the processor.

21. The system as recited in claim 17 wherein the multithreaded processing system works in a multiprocessor environment, each of the multiple processors having a separate floating thread stack associated with it.

22. The system as recited in claim 17 wherein the operating system managing the scheduling of threads comprises:
a. a scheduler ready queue holding threads that are ready for execution;
b. a normal thread preemption module providing preemptive services to normal threads, the preemptive services being specific activities that might preempt a thread; and
c. a floating thread preemption module providing preemptive services to floating threads.

23. The system as recited in claim 19 wherein the floating thread compiler further comprises:
a. means for saving reference information related to the floating thread in a thread store in response to a preemptive function call, the thread store being associated with the thread; and
b. means for setting up the floating thread stack in response to a preemptive function call, the setting up being done in a manner such that the no context information needs to be stored for the thread in case the thread is preempted during a preemptive function call.

24. A floating thread compiler compiling an application code, the application code comprising a plurality of floating threads, each floating thread comprising a main level function and other sub-functions, the main level function being the basic execution level function making calls to other sub-functions, the sub-functions having been written using a function calling convention, the convention ensuring minimal thread switching overheads and reduced memory usage during application execution by not requiring any reference information to be saved in the main memory when the thread is swapped out, the floating thread compiler comprising:
a. a main level function compiler compiling the main level function of the floating thread;
b. a non-preemptive function compiler compiling sub-functions that are non-preemptive in nature, the non preemptive functions being those functions that cannot stall the thread at any stage of execution, the non-preemptive functions being called from the main level function or any sub-function called by the main level function, the non-preemptive functions being capable of making calls to other non-preemptive functions only; and
c. a preemptive function compiler compiling sub-functions that are preemptive in nature, the preemptive functions being those functions that may cause a thread to temporarily stall and yield control back to the operating system, the preemptive functions being called from the main level function only, the preemptive functions being capable of making calls to other non-preemptive functions only.

25. The floating thread compiler as recited in claim 24 further comprising:
a. means for identifying the main level, preemptive and non-preemptive function blocks within the floating thread; and
b. means for activating the appropriate function compiler for compiling each of the functions.

26. A computer program product for minimizing thread switching overheads and memory usage while executing a multithreaded application program, the program having been written using floating threads, the floating threads following a function calling convention, the convention ensuring minimal switching overheads by not requiring any reference information to be saved in the main memory when the thread is swapped out, the computer program product comprising:
a computer readable medium comprising:
a. program instruction means for compiling floating threads in accordance with the function calling convention being followed by the floating threads; and
b. program instruction means for executing the compiled application program.

27. The computer program product as recited in claim 26 wherein the computer readable medium comprising program instruction means for compiling the floating threads further comprises:
a. program instruction means for compiling main level function, the main level function being the basic execution level function of the thread, the main level function making all subsequent calls to other functions;
b. program instruction means for compiling non-preemptive functions, non-preemptive functions being normal functions that do not stall the thread at any stage of execution, the non-preemptive functions being called from the main level function or any sub-function called by the main level function, the non-preemptive functions being capable of making calls to other non-preemptive functions only;
c. program instruction means for compiling preemptive functions, the preemptive functions being those functions that may cause a thread to temporarily stall and yield control to the operating system, the preemptive functions being called from the main level function only, the preemptive functions being capable of making calls to other non-preemptive functions; and
d. program instruction means for compiling other program constructs.
